(19) United States
(12) Patent Application Publication
(10) Pub. No.: US 2019/0171803 A1
(43) Pub. Date: Jun. 6, 2019

(54) METHOD AND APPARATUS FOR USER AUTHENTICATION BASED ON TOUCH INPUT INCLUDING FINGERPRINT INFORMATION

(71) Applicant: Jae Kwang BAE, Seoul (KR)

(72) Inventor: Jae Kwang BAE, Seoul (KR)

(21) Appl. No.: 16/302,503

(22) PCT Filed: May 12, 2017
(86) PCT No.: PCT/KR2017/004951

§ 371 Date: Nov. 16, 2018

(30) Foreign Application Priority Data
May 16, 2016 (KR) 10-2016-0059407

(51) Int. Cl. G06F 21/32; G06K 9/00; G06F 21/40; G06F 3/0488

(52) U.S. Cl. CPC G06F 21/32; G06F 3/0488; G06F 21/40; G06K 9/00087

(57) ABSTRACT

The present invention provides a method for user authentication through the input of a password, the method for user authentication having enhanced security by determining whether or not a particular symbol or a symbol positioned in a particular position, among the symbols constituting the password, is input via a touch input including particular fingerprint information, in addition to determining the matching status of the password. Also provided is a user authentication method which can protect a user's personal information from others by using, in user authentication, the use status of a touch input including fingerprint information which is unlikely to be exposed by the others.

### TECHNICAL FIELD

The following embodiments are related to a method and apparatus for performing user authentication and, more particularly, to a method and system for performing user authentication when a touch input including fingerprint information is detected.

### BACKGROUND ART

In executing a specific application or obtaining information or service using a user terminal, such as a mobile terminal, user authentication may be required. In general, user authentication may be completed when a user enters a desired password. In this case, it is difficult to consider that user authentication based on the entry of such a password is safe in terms of security because others can access corresponding information or service like a corresponding user if the password is exposed to others or others obtain the password.

Recently, in order to supplement a user authentication method based on the entry of a password, a user authentication method using a user's bio information is proposed. The authentication method using bio information includes a user authentication method using fingerprint recognition and a user authentication method using iris recognition, for example. In particular, the user authentication method using fingerprint recognition has been applied to various user terminals including smartphones and tablet PCs.

However, the user authentication method using fingerprint recognition has a possibility that an authentication system may be incapacitated using a forge fingerprint or using a duplication fingerprint. Accordingly, even in the user authentication method using fingerprint recognition, a user authentication method having further enhanced security is still required.

Korean Patent Application Publication No. 10-2004-0039998 (May 12, 2004) discloses a security system using fingerprint recognition, including a fingerprint scan unit generating a fingerprint image when a fingerprint is touched, a fingerprint image storage unit storing a representative reference fingerprint image and at least one assistant reference fingerprint image for each user, and a control unit identifying whether a representative reference fingerprint image identical with the first input fingerprint image input through the fingerprint scan unit is present, reading a corresponding assistant reference fingerprint image when the same representative reference fingerprint image is present, and determining user authentication by comparing an input fingerprint image after the input fingerprint image with the assistant reference fingerprint image.

The above-described information is merely for helping understanding, may include contents not forming part of a conventional technology, and may not include contents which may be presented to those skilled in the art by a conventional technology.

### DISCLOSURE

### Technical Problem

An embodiment may provide a method of completing user authentication by comparing specific authentication information with authentication information pre-configured in a user terminal using the entry of a password, including a touch input including specific fingerprint information, as the specific authentication information.

An embodiment may provide a method of completing user authentication by determining whether a specific symbol of symbols configuring a password or a symbol positioned at a specific location among the symbols is input by a touch input including specific fingerprint information, in the entry of the password.

### Technical Solution

In an aspect, there is provided a method of authenticating a user, including receiving the entry of a desired password, including a touch input including at least one piece of given fingerprint information and an input of at least one symbol including one or more of a number, letter and special letter, as authentication information through a user terminal, determining whether authentication information pre-configured in the user terminal and the received authentication information are identical, and completing the user authentication of a user in response that the pre-configured authentication information and the received authentication information are identical.

The pre-configured authentication information may include identification information indicative of an input pattern of the entry of the desired password.

The determining may include determining whether the input pattern of the entry of the desired password is identical with an input pattern indicated by the identification information.

The identification information may include information indicative of a condition for a symbol to be input by the touch input including the given fingerprint information among the at least one symbol configuring the desired password.

The determining may include determining whether the entry of the desired password associated with the received authentication information satisfies the condition.

The symbol to be input by the touch input including the given fingerprint information may be a given letter, a given number or a given special letter.

The desired password may include N symbols.

The N may be an integer of 2 or more.

The symbol to be input by the touch input including the given fingerprint information may be a symbol located at a K-th place within the password.

The K may be an integer of 1 or more to N or less.

The given fingerprint information may be information indicative of the fingerprint of at least one of the fingers of both hands of the user.

The desired password may include a plurality of symbols.

The symbol to be input by the touch input including the given fingerprint information is plural.

The touch input may include a first touch input including first fingerprint information and a second touch input including second fingerprint information as a plurality of touch inputs.

The identification information may include information indicative of the condition in which a first symbol of the symbols configuring the desired password has to be input by the first touch input and a second symbol of the symbols configuring the desired password has to be input by the second touch input.

The first fingerprint information and the second fingerprint information may indicate fingerprints of different fingers of the user.

The method may further include outputting an interface including the indication information of the input pattern.

The indication information may include at least one of information regarding that the given fingerprint information indicates the fingerprint of which finger and information indicating that which one of the at least one symbol configuring the desired password has to be input by the touch input.

### Advantageous Effects

There is provided a user authentication method having enhanced security by determining whether a specific symbol of symbols configuring a password or a symbol positioned at a specific location among the symbols is input by a touch input including specific fingerprint information in addition to a determination of whether the password is identical in a user authentication method through the entry of a password.

There is provided a user authentication method capable of protecting a user's personal information against others because whether a touch input including fingerprint information that is difficult to be exposed to others is used is used for user authentication.

### DESCRIPTION OF DRAWINGS

FIG. 1 shows a user authentication method based on a touch input including given fingerprint information according to an embodiment.

FIG. 2 shows a user terminal performing a user authentication method according to an embodiment.

FIG. 3 is a flowchart showing a user authentication method based on a touch input including given fingerprint information according to an embodiment.

FIGS. 4a and 4b show a method of entering a password using a touch input including given fingerprint information according to an example.

FIG. 5 is a flowchart showing a method of outputting indication information for the input pattern of a desired password according to an example.

### BEST MODE FOR INVENTION

Hereinafter, embodiments are described in detail with reference to the accompanying drawings. The same reference numeral presented in each drawing denotes the same member.

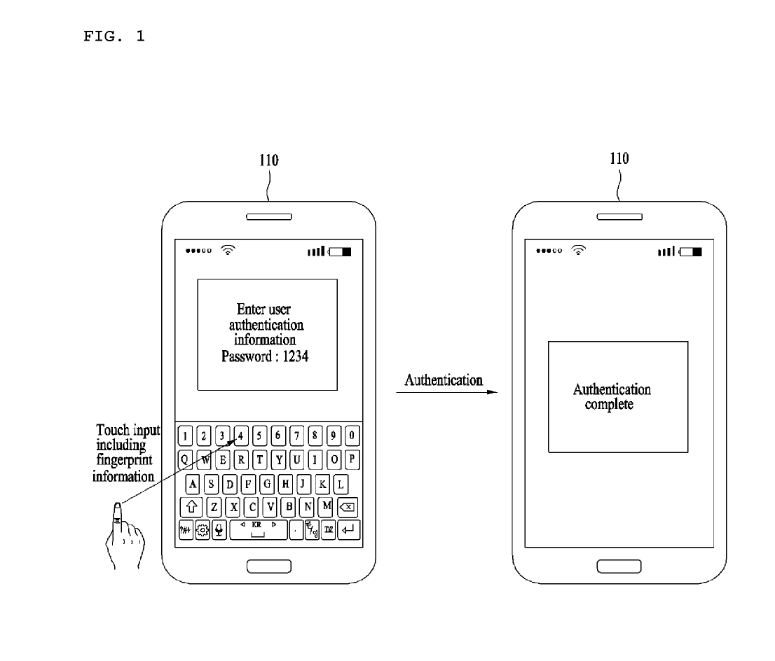

FIG. 1 shows a user authentication method based on a touch input including given fingerprint information according to an embodiment.

FIG. 1 shows a method of performing user authentication by entering a password using a touch input including given fingerprint information in performing user authentication through a user terminal 110. The user authentication may be an operation necessary to release lock, execute a specific application or execute given transactions and obtain desired information for the user terminal 110. For example, the user authentication may be login for a lock release operation or specific service for the user terminal 110.

The user terminal 110 may include a touch screen. In performing user authentication, as shown, an interface for prompting a user to input user authentication information may be displayed on the touch screen of the user terminal 110. The user may enter a desired password using a touch input through a keyboard displayed on the touch screen. The user terminal 110 may perform user authentication using the entered password.

The user terminal 110 may include a fingerprint recognition sensor. A user may input a touch input, including at least one piece of fingerprint information, to the user terminal 110 through the fingerprint recognition sensor.

The fingerprint recognition sensor may be an element of the user terminal 110, which is different from a display device. If the display device includes a touch screen, however, the touch panel of the touch screen may include the fingerprint recognition sensor. Alternatively, a panel in which the touch panel and the fingerprint recognition sensor are integrated may be configured.

In embodiments, a “touch input including fingerprint information” may be used as a term, including both a fingerprint input (fingerprint information input) to a fingerprint recognition sensor, that is, a separate element of a display device, and a fingerprint input to a touch screen including a fingerprint recognition sensor.

In the illustrated example, the desired password may be 1234. The user terminal 110 may compare authentication information, including the entered password, with authentication information pre-configured in the user terminal 110, may determine whether the authentication information is identical with the pre-configured authentication information, and may complete user authentication when the authentication information input by a user is identical with the pre-configured authentication information.

The authentication information pre-configured in the user terminal 110 may include information on the input pattern of a password in addition to information on the password itself. Such information on an input pattern may require that a given symbol included in a password (or a symbol included at a given location within a password) through a touch input including given (specific) fingerprint information. In the illustrated example, a user may input the number “4”, included in the password, by a touch input including given fingerprint information. The user terminal 110 may determine whether 4 has been input by a touch input including given fingerprint information, and may complete user authentication only when 4 is input by a touch input including given fingerprint information.

Accordingly, although the password 1234 is exposed to others not the user, security for the user terminal 110 can be maintained unless an input pattern of the password including a touch input including given fingerprint information is exposed.

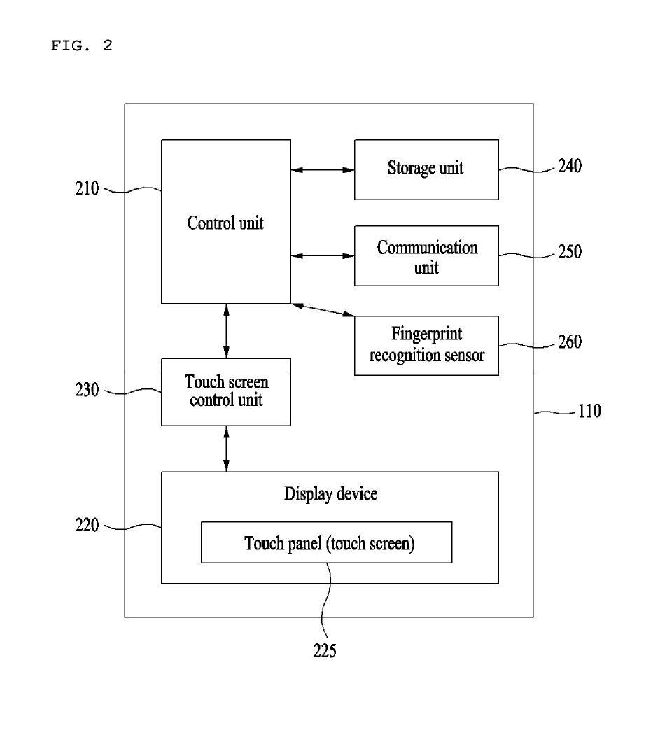

A detailed configuration of the user terminal 110 and a detailed user authentication method using a touch input including given fingerprint information are described more specifically with reference to FIGS. 2 to 4b to be later.

FIG. 2 shows a user terminal performing a user authentication method according to an embodiment.

The user terminal 110 may be a personal computer (PC), a notebook computer, a laptop computer, a smartphone, a tablet PC or a wearable computer.

The user terminal 110 may include a display device 220, a control unit 210 and a communication unit 250. Furthermore, if the display device 220 includes a touch screen 225, the user terminal 110 may further include a touch screen control unit 230 for controlling the touch screen 225. The touch screen control unit 230 may be configured in the control unit 210.

Furthermore, the user terminal 110 may include a fingerprint recognition sensor 260. A user may input a touch input, including at least one piece of fingerprint information, to the user terminal 110 through the fingerprint recognition sensor 260. The fingerprint recognition sensor 260 may be an element of the user terminal 110, which is separated from the display device 220. Alternatively, if the display device 220 includes the touch screen 225, the touch panel of the touch screen 225 may include the fingerprint recognition sensor 260, unlike in the illustrated example. Alternatively, the touch panel of the touch screen 225 may form a panel with which the fingerprint recognition sensor 260 has been integrated.

The display device 220 may display information processed by the control unit 210, an interface requesting a user to enter a password, and an interface indicative of the completion or failure of user authentication. Furthermore, the display device 220 may display a password being entered by a user. The entered password may be exposed without any change or may be changed into a symbol, such as *, and displayed on the display device 220.

For example, the display device 220 may include a liquid crystal display (LCD), a light emitting diode (LED) display and an organic light emitting diode (OLED) display.

The touch screen 225 may detect at least one touch input from the user of the user terminal 110. For example, the user may control the user terminal 110 through the touch screen 225 or may control an object displayed on the touch screen 225. The touch screen 225 may be controlled by the touch screen control unit 230.

The touch screen 225 may be controlled by the touch screen control unit 230. The touch screen 225 may be configured to detect a touch input including fingerprint information (i.e., if the touch screen 225 and the fingerprint recognition sensor 260 are configured in an integrated type).

The control unit 210 may manage the elements of the user terminal 110 and execute a program or application used by the user terminal 110. For example, the control unit 210 may process user authentication and execute an application that requires user authentication. Furthermore, the control unit 210 may process operation necessary for the execution of a program or application and the processing of data. The control unit 210 may be at least one processor of the user terminal 110 or at least one core within the processor.

The communication unit 250 may be a device for communication with other terminal(s) or server different from the user terminal 110. For example, if user authentication is performed in association with an external server not the user terminal 110, authentication information including a password entered by a user may be transmitted to an external server through the communication unit 250. Information indicative of the results of user authentication may be received through the communication unit 250.

Although not shown, the communication unit 250 may include one or more antennas for the transmission and reception of a signal and information to and from other terminal(s) or server. The communication unit 250 may be the network interface card of the user terminal 110, a hardware module, such as a network interface chip and a networking interface port, or a software module, such as a network device driver or a networking program.

The user terminal 110 may further include a storage unit 240 for storing data or information. The storage unit 240 may store information related to user authentication in addition to a program or application executed by the control unit 210 and information related to the program or application.

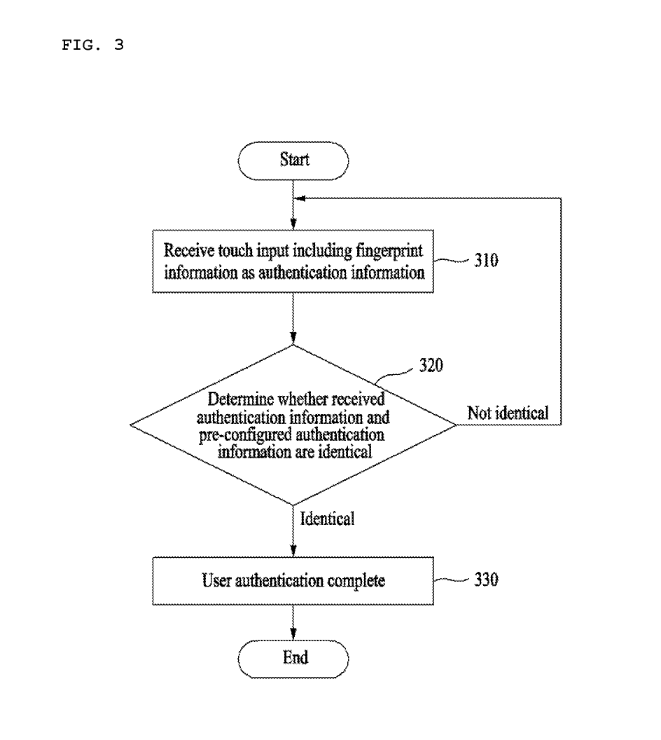

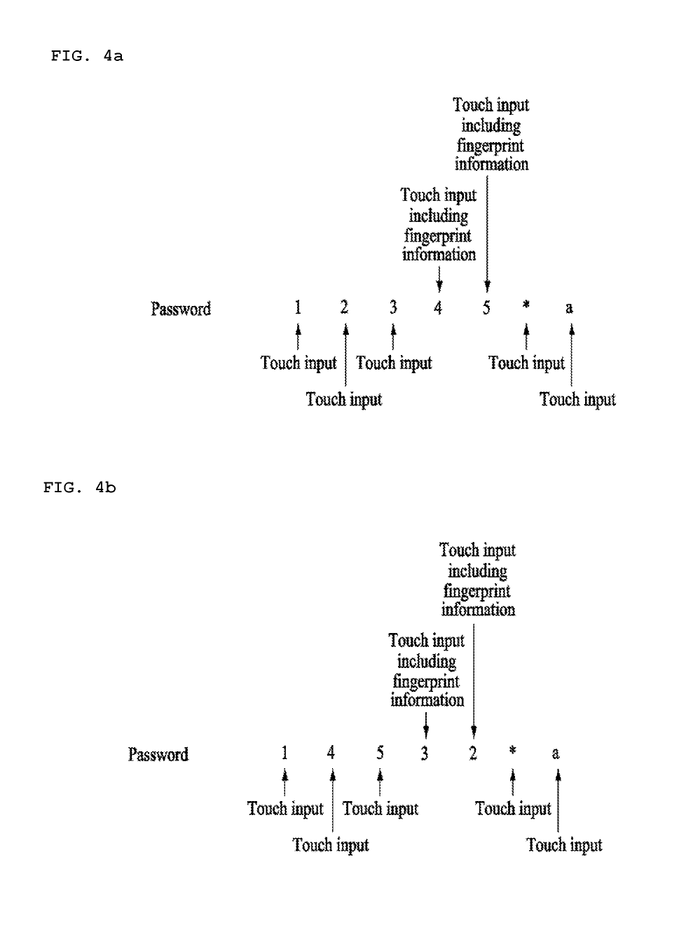

A detailed method of performing user authentication using a touch input including given fingerprint information input through the user terminal 110 is described more specifically with reference to FIGS. 3 to 4b.

The technical contents described with reference to FIG. 1 may be applied without any change, and thus a detailed description thereof is omitted below.

FIG. 3 is a flowchart showing a user authentication method based on a touch input including given fingerprint information according to an embodiment.

In step 310, the control unit 210 of the user terminal 110 may receive the entry of a desired password, including a touch input including at least one piece of given fingerprint information and the input of at least one symbol, as authentication information through the fingerprint recognition sensor 260 (or touch screen 225) of the user terminal 110. The entry of the desired password may include the input of at least one symbol including one or more of a number, letter and special letter. In other words, the desired password may have a plurality of symbols. Each of the plurality of symbols may be a number, letter or special letter. The touch input, including given fingerprint information included in the entry of the password, may be applied when at least one symbol(s) configuring the password is input or may be performed before and/or after the input of a symbol(s) separately from the input of the symbol(s) configuring the password. In other words, the desired password may include a touch input, including at least one symbol and at least one piece of given fingerprint information.

The fingerprint information included in the touch input may be information indicative of the fingerprint of at least one finger of the fingers (e.g., a thumb, a middle finger, an index finger, a ring finger (third finger), and a little finger) of both hands of a user.

A touch input including input given fingerprint information is a plurality of touch inputs, and each of the touch inputs may include given fingerprint information. For example, a touch input including input given fingerprint information may include a first touch input, including first fingerprint information, and a second touch input, including second fingerprint information, as a plurality of touch inputs. In this case, the first fingerprint information and the second fingerprint information may be information indicative of the fingerprints of different fingers. Alternatively, the first fingerprint information and the second fingerprint information may be information indicative of the fingerprint of the same finger of a user (the same fingerprint information). In other words, fingerprint information input through the fingerprint recognition sensor 260 (or touch screen 225) may be fingerprint information (i.e., the same fingerprint information) of the same finger of the same user or may be fingerprint information (i.e., fingerprint information of the same/different finger of another hand or fingerprint information of a different finger of the same hand) of different fingers of the same user. Alternatively, a plurality of pieces of input fingerprint information may be fingerprint information by a plurality of users.

In order for user authentication to be completed, the entry of a desired password may need to be performed to satisfy a desired input pattern. For example, at least one symbol forming a desired password or a symbol(s) at a given location among desired symbols configuring a password may need to be input through a touch input, including given fingerprint information, not a common touch input.

In described embodiments, a “touch input including given fingerprint information” may mean a “touch input including specific fingerprint information.” Specific (given) fingerprint information may mean fingerprint information compared or determined with respect to fingerprint information included in authentication information pre-configured by the control unit 210, in step 320 to be described later. “Common touch input” may also include fingerprint information, but fingerprint information included in the “common touch input” may not be compared or determined with respect to fingerprint information included in authentication information pre-configured by the control unit 210.

In step 320, the control unit 210 of the user terminal 110 may determine whether authentication information pre-configured with respect to the user terminal 110 and the received authentication information are identical.

The pre-configured authentication information may be previously configured by the user of the user terminal 110, and may be processed and generated by the control unit 210 and stored in the storage unit 240. The pre-configured authentication information may include information on a symbol(s) configuring a desired password.

Furthermore, the pre-configured authentication information may include identification information indicative of the input pattern of the entry of a desired password. The control unit 210 may determine whether the input pattern of the entry of a desired password of a user is identical with an input pattern indicated by identification information included in authentication information pre-configured in the user terminal 110.

The input pattern may indicate that a touch input including given fingerprint information must be applied to which one of symbols configuring a desired password or that a touch input including given fingerprint information must be applied to a symbol at which location. In other words, the identification information may include information indicative of a condition for a symbol that needs to be input by a touch input, including given fingerprint information, among at least one symbol configuring a desired password. In this case, the control unit 210 may determine whether the entry of a desired password associated with authentication information input and received from a user satisfies the condition. The condition for a symbol that needs to be input by a touch input including given fingerprint information may have been pre-configured by the user of the user terminal 110.

For example, the identification information may include information indicating that a given (specific) symbol(s) of symbols configuring a desired password must be input by a touch input including given fingerprint information. In this case, the control unit 210 may identify and determine whether the given symbol, that is, a given letter, a given number or a given special letter configuring a desired password has been input by a touch input including given fingerprint information.

Alternatively, the identification information may include information indicating that a symbol(s) located at a given location among symbols configuring a desired password must be input by a touch input including given fingerprint information. For example, if a desired password includes N symbols (N is an integer of 2 or more), a symbol that must be input by a touch input including given fingerprint information may be a symbol located at a K-th place within the desired password (K is an integer of 1 or more to N or less).

If a desired password includes a plurality of symbols, a symbol that must be input by a touch input including given fingerprint information may be plural.

In such an embodiment, in step 310, a touch input including given fingerprint information input by a user may be plural. For example, when a user enters a desired password, in order to input symbols configuring the desired password, the user may input touch inputs, including a first touch input including first fingerprint information and a second touch input including second fingerprint information, through the fingerprint recognition sensor 260 (or touch screen 225). In other words, the control unit 210 may receive authentication information, including a first touch input including first fingerprint information and a second touch input including second fingerprint information, through the fingerprint recognition sensor 260 (or touch screen 225). In this case, identification information included in the pre-configured authentication information may include information indicative of a condition in which the first symbol of the symbols configuring the desired password must be input by the first touch input including the first fingerprint information and that the second symbol of the symbols configuring the desired password must be input by the second touch input including the second fingerprint information. In this case, the first symbol and the second symbol may be the same or different. Additionally or alternatively, the first fingerprint information and the second fingerprint information may be the same or different. The control unit 210 may determine whether a first symbol configuring an entered desired password is input by a first touch input including first fingerprint information, and may determine whether a second symbol configuring an entered desired password is input by a second touch input including second fingerprint information.

If a result of the determination is to be not identical, the user terminal 110 may request the user to input authentication information again. At this time, an interface to request the input of the authentication information may be displayed on the display device 220.

In determining whether pre-configured authentication information is identical with input fingerprint information, only when a touch input corresponding to a symbol or location of a desired password configured to be input by the touch input including given fingerprint information in the pre-configured authentication information is received, the control unit 210 may determine whether given fingerprint information included in the pre-configured authentication information (in addition to a determination of whether the pre-configured authentication information and an input symbol are identical) and the input fingerprint information are identical. In other words, when a touch input corresponding to a symbol or location of a desired password that does not need to be input by a touch input including given fingerprint information is received, the control unit 210 may determine only whether an input symbol and pre-configured authentication information are identical regardless of whether the corresponding touch input includes the fingerprint information.

In step 330, the control unit 210 of the user terminal 110 may complete the user authentication for the user who has input the authentication information in response that the pre-configured authentication information and the authentication information received in step 310 are identical. When the user authentication is completed, a message indicating that the user authentication has been completed may be displayed on the touch screen 225, as shown FIG. 1.

As described above, the user terminal 110 may be a PC, a notebook computer, a laptop computer, a smartphone, a tablet PC or a wearable computer.

In the above-described embodiment, the entry of a password including a touch input including fingerprint information has been illustrated as being performed using the touch screen 225 (i.e., the touch screen 225 including the fingerprint recognition sensor 260), but a corresponding touch input may be performed by another input device capable of performing a touch input including fingerprint information. For example, a touch input including fingerprint information may be performed using a keyboard capable of recognizing fingerprint information, a mouse capable of recognizing fingerprint information or a tablet capable of recognizing fingerprint information.

In other words, a touch input including fingerprint information and the entry of a password described in the embodiments are not limited to execution using the touch screen 225 and may be performed using other input devices capable of recognizing a touch input including fingerprint information and receiving a password.

The technical contents described with reference to FIGS. 1 and 2 may be applied without any change, and thus a detailed description thereof is omitted below.

FIGS. 4a and 4b show a method of entering a password using a touch input including given fingerprint information according to an example.

FIGS. 4a and 4b show embodiments in which given symbols of symbols configuring a desired password are input through a touch input including given fingerprint information or symbols located at given locations among symbols configuring a desired password are input through a touch input including given fingerprint information.

In FIG. 4a, a desired password is assumed to be 12345*a. In the corresponding example, authentication information pre-configured in the user terminal 110 has been configured so that the symbols 4 and 5 must be input by touch inputs including given fingerprint information. As shown, when the desired password 12345*a is sequentially entered, when the symbols 4 and 5 are input by touch inputs including given fingerprint information and the remaining symbols are input by a common touch input, user authentication may be completed validly.

In the example, given fingerprint information included in the touch input for inputting the symbol 4 and given fingerprint information included in the touch input for inputting the symbol 5 may be different. In other words, the pre-configured authentication information may have been configured so that the symbol 4 and the symbol 5 must be input by different fingers.

Meanwhile, in FIG. 4b, a desired password is assumed to be 14532*a. In the corresponding example, authentication information pre-configured in the user terminal 110 has been configured so that symbols located at the fourth and fifth places of a seven-digit password must be input by touch inputs including given fingerprint information. Accordingly, 3 and 2 must be input by touch inputs including given fingerprint information. As shown, when the desired password 14532*a is sequentially input, when the symbols 3 and 2 are input by touch inputs including given fingerprint information and the remaining symbols are input by a common touch input, user authentication may be completed validly.

In the example, given fingerprint information included in the touch input for inputting the symbol 3 and given fingerprint information included in the touch input for inputting the symbol 2 may be different. In other words, pre-configured authentication information may have been configured so that the symbol 3 and symbol 2 must be input by different fingers.

The above-described examples may be combined. For example, pre-configured authentication information may be configured so that a specific symbol of symbols configuring a desired password must be input by a touch input including given fingerprint information and a symbol located at a specific location among the symbols configuring the desired password must be input by a touch input including given fingerprint information.

Furthermore, unlike in the illustrated example, pre-configured authentication information may be configured so that all symbols configuring a password must be input through respective touch inputs including given fingerprint information. In this case, given fingerprint information that must be input in association with at least two of the symbols or at least two of locations where the symbols are positioned may be different.

The technical contents described with reference to FIGS. 1 to 3 may be applied without any change, and thus a detailed description thereof is omitted below.

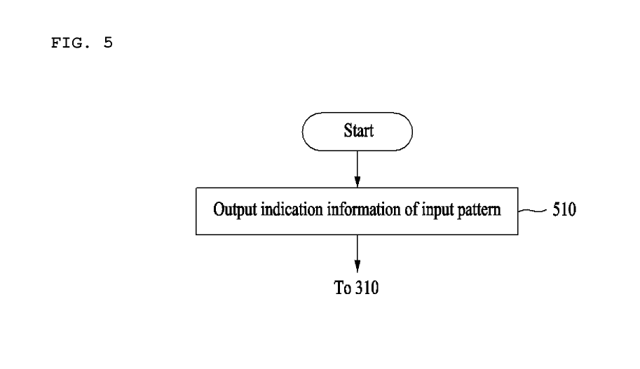

FIG. 5 is a flowchart showing a method of outputting indication information for the input pattern of a desired password according to an example.

In step 510, the control unit 210 may output indication information about the input pattern of the entry of a desired password, included in pre-configured authentication information, through the display device 220. The indication information may indicate a hint or recommendation for the input pattern of the entry of the desired password to be entered. In other words, a user may obtain a hint for the entry of the desired password through the output indication information. The indication information may be displayed on the display device 220 as a user interface.

The indication information may include at least one of information regarding that given fingerprint information included in a touch input to be performed indicates the fingerprint(s) of which finger(s) and information indicating that which symbol(s) (or a symbol at which location(s)) of at least one symbol(s) configuring a desired password must be input by a touch input including given fingerprint information.

For example, if a desired password includes a plurality of symbols and a symbol that must be input by a touch input including given fingerprint information is plural, indication information displayed on the display device 220 may include information indicating that which symbol(s) must be input by a touch input including given fingerprint information. That is, if a desired password is “1234” and “2” and “3” must be input by a touch input including given fingerprint information, a message, reading [Enter “2” (or “2” and “3”) through a touch input including fingerprint information], may be displayed on the display device 220.

Additionally or alternatively, indication information displayed on the display device 220 may include information, indicating that a symbol(s) that must be input by a touch input including given fingerprint information must be input by a touch input including fingerprint information of which finger. That is, if a desired password is “1234”, “2” must be input by a touch input including fingerprint information of a thumb, and “3” must be input by a touch input including fingerprint information of an index finger, a message, reading [Enter “2” through a touch input including fingerprint information of a thumb], may be displayed on the display device 220 (in addition, a message, reading [Enter “3” through a touch input including fingerprint information of an index finger], may be displayed).

A unique identifier may be assigned to each finger of both hands of a user. For example, an identification number, such as any one of 1 to 10, may be assigned to each finger. Alternatively, both hands of a user may be divided into “left (left hand)” and “right (right hand)”, and an identification symbol, such as any one of left1 to left5 or any one of right1 to right5, may be assigned to each finger. Indication information displayed on the display device 220 may be displayed in association with the above-described identification number or identification symbol.

The technical contents described with reference to FIGS. 1 to 4b may be applied without any change, and thus a detailed description thereof is omitted below.

The aforementioned apparatus may be implemented in the form of a combination of hardware elements, software elements and/or hardware elements and software elements. For example, the apparatus and elements described in the embodiments may be implemented using one or more general-purpose computers or special-purpose computers, for example, a processor, a controller, an arithmetic logic unit (ALU), a digital signal processor, a microcomputer, a field programmable array (FPA), a programmable logic unit (PLU), a microprocessor or any other device capable of executing or responding to an instruction. The processing device may perform an operating system (OS) and one or more software applications executed on the OS. Furthermore, the processing device may access, store, manipulate, process and generate data in response to the execution of software. For convenience of understanding, one processing device has been illustrated as being used, but a person having ordinary skill in the art may be aware that the processing device may include a plurality of processing elements and/or a plurality of types of processing elements. For example, the processing device may include a plurality of processors or a single processor and a single controller. Furthermore, other processing configurations, such as a parallel processor, are also possible.

Software may include a computer program, code, an instruction or one or more combinations of them and may configure the processing device so that it operates as desired or may instruct the processing device independently or collectively. The software and/or data may be interpreted by the processing device or may be embodied in a machine, component, physical device, virtual equipment or computer storage medium or device of any type or a transmitted signal wave permanently or temporarily in order to provide an instruction or data to the processing device. The software may be distributed to computer systems connected over a network and may be stored or executed in a distributed manner. The software and data may be stored in one or more computer-readable recording media.

The method according to the embodiment may be implemented in the form of a program instruction executable by various computer means and stored in a computer-readable recording medium. The computer-readable recording medium may include a program instruction, a data file, and a data structure solely or in combination. The program instruction recorded on the recording medium may have been specially designed and configured for the embodiment or may be known to those skilled in computer software. The computer-readable recording medium includes a hardware device specially configured to store and execute the program instruction, for example, magnetic media such as a hard disk, a floppy disk, and a magnetic tape, optical media such as CD-ROM or a DVD, magneto-optical media such as a floptical disk, ROM, RAM, or flash memory. Examples of the program instruction may include both machine-language code, such as code written by a compiler, and high-level language code executable by a computer using an interpreter. The hardware device may be configured in the form of one or more software modules for executing the operation of the embodiment, and the vice versa.

### MODE FOR INVENTION

As described above, although the embodiments have been described in connection with the limited embodiments and the drawings, those skilled in the art may modify and change the embodiments in various ways from the description. For example, proper results may be achieved although the aforementioned descriptions are performed in order different from that of the described method and/or the aforementioned elements, such as the system, configuration, device, and circuit, are coupled or combined in a form different from that of the described method or replaced or substituted with other elements or equivalents.

1. A method of authenticating a user, comprising:
receiving an entry of a desired password, comprising a touch input comprising at least one piece of given fingerprint information and an input of at least one symbol comprising one or more of a number, letter and special letter, as authentication information through a user terminal;
determining whether authentication information pre-configured in the user terminal and the received authentication information are identical; and
completing user authentication of a user in response that the pre-configured authentication information and the received authentication information are identical.

2. The method of claim 1, wherein:
the pre-configured authentication information comprises identification information indicative of an input pattern of the entry of the desired password, and
the determining comprises determining whether the input pattern of the entry of the desired password is identical with an input pattern indicated by the identification information.

3. The method of claim 2, wherein:
the identification information comprises information indicative of a condition for a symbol to be input by the touch input including the given fingerprint information among the at least one symbol configuring the desired password, and
the determining comprises determining whether the entry of the desired password associated with the received authentication information satisfies the condition.

4. The method of claim 3, wherein the symbol to be input by the touch input including the given fingerprint information is a given letter, a given number or a given special letter.

5. The method of claim 3, wherein:
the desired password comprises N symbols,
the N is an integer of 2 or more,
the symbol to be input by the touch input including the given fingerprint information is a symbol located at a K-th place within the password, and
the K is an integer of 1 or more to N or less.

6. The method of claim 1, wherein the given fingerprint information is information indicative of a fingerprint of at least one of fingers of both hands of the user.

7. The method of claim 3, wherein:
the desired password comprises a plurality of symbols, and
the symbol to be input by the touch input including the given fingerprint information is plural.

8. The method of claim 7, wherein:
the touch input comprises a first touch input comprising first fingerprint information and a second touch input comprising second fingerprint information as a plurality of touch inputs, and
the identification information comprises information indicative of the condition in which a first symbol of the symbols configuring the desired password has to be input by the first touch input and a second symbol of the symbols configuring the desired password has to be input by the second touch input.

9. The method of claim 8, wherein the first fingerprint information and the second fingerprint information indicate fingerprints of different fingers of the user.

10. The method of claim 2, further comprising outputting the indication information of the input pattern,
wherein the indication information comprises at least one of information regarding that the given fingerprint information indicates a fingerprint of which finger and information indicating that which one of the at least one symbol configuring the desired password has to be input by the touch input.
